(19) United States
(12) Patent Application Publication
(10) Pub. No.: US 2025/0265474 A1
(43) Pub. Date: Aug. 21, 2025

(54) INFORMATION PROCESSING APPARATUS, INFORMATION PROCESSING METHOD, AND NON-TRANSITORY RECORDING MEDIUM

(71) Applicants: Satoshi Takagi, KANAGAWA (JP); Kenichiro Nakao, TOKYO (JP); Tomoyasu Aizaki, KANAGAWA (JP)

(72) Inventors: Satoshi Takagi, KANAGAWA (JP); Kenichiro Nakao, TOKYO (JP); Tomoyasu Aizaki, KANAGAWA (JP)

(73) Assignee: Ricoh Company, Ltd., Tokyo (JP)

(21) Appl. No.: 19/021,778

(22) Filed: Jan. 15, 2025

(30) Foreign Application Priority Data
Feb. 21, 2024 (JP) 2024-024665

(51) Int. Cl. G06N 3/098

(52) U.S. Cl. CPC G06N 3/098

(57) ABSTRACT

An information processing apparatus includes circuitry to register data of local models on which machine learning has been performed using a set of data held by the information processing apparatus, and receive a designation of a scope in which use of the data is permitted, the local models to be integrated into a global model using federated learning.

### CROSS-REFERENCE TO RELATED APPLICATIONS

This patent application is based on and claims priority pursuant to 35 U.S.C. § 119 (a) to Japanese Patent Application No. 2024-024665, filed on Feb. 21, 2024, in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Related Art

The federated learning is a machine learning technique to perform learning while leaving data distributed, rather than aggregating the data. The federated learning enables construction of a model among multiple client apparatuses (information processing apparatuses) using learning data as if individual pieces of the data were linked, while ensuring privacy and security.

As an example of such federated learning, a technique is known in which individual nodes (information processing apparatuses) learn a local model of own and a server apparatus updates the data of a global model based on the data of each local model obtained from each node.

### SUMMARY

In one aspect, an information processing apparatus includes circuitry to register data of local models on which machine learning has been performed using a set of data held by the information processing apparatus, and receive a designation of a scope in which use of the data is permitted, the local models to be integrated into a global model using federated learning.

In another aspect, an information processing method performed by an information processing apparatus, includes registering data of local models on which machine learning has been performed using a set of data held by the information processing apparatus, and receiving a designation of a scope in which use of the data is permitted, the local models to be integrated into a global model using federated learning.

In another aspect, a non-transitory recording medium stores a plurality of program codes which, when executed by a computer, causes the computer to perform a method including registering data of local models on which machine learning has been performed using a set of data held by the information processing apparatus, and receiving a designation of a scope in which use of the data is permitted, the local models to be integrated into a global model using federated learning.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an information processing system;

FIG. 2 is a block diagram illustrating a hardware configuration of an information processing apparatus included in the information processing system of FIG. 1;

FIG. 3A is a block diagram illustrating a functional configuration of an information processing apparatus;

FIG. 3B is a block diagram illustrating a functional configuration of a management apparatus;

FIG. 4 is a flowchart of the processing executed until a client apparatus participates in federated learning;

FIG. 5 is a diagram illustrating a model use permission setting screen;

FIG. 6 is a diagram illustrating a screen used for selecting a federation partner;

FIG. 7 is a diagram illustrating a screen used for applying for the use of a model;

FIG. 8 is a diagram illustrating a screen used for approving or rejecting an application for the use of a model; and

FIG. 9 is a flowchart of the processing to construct a model using federated learning.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

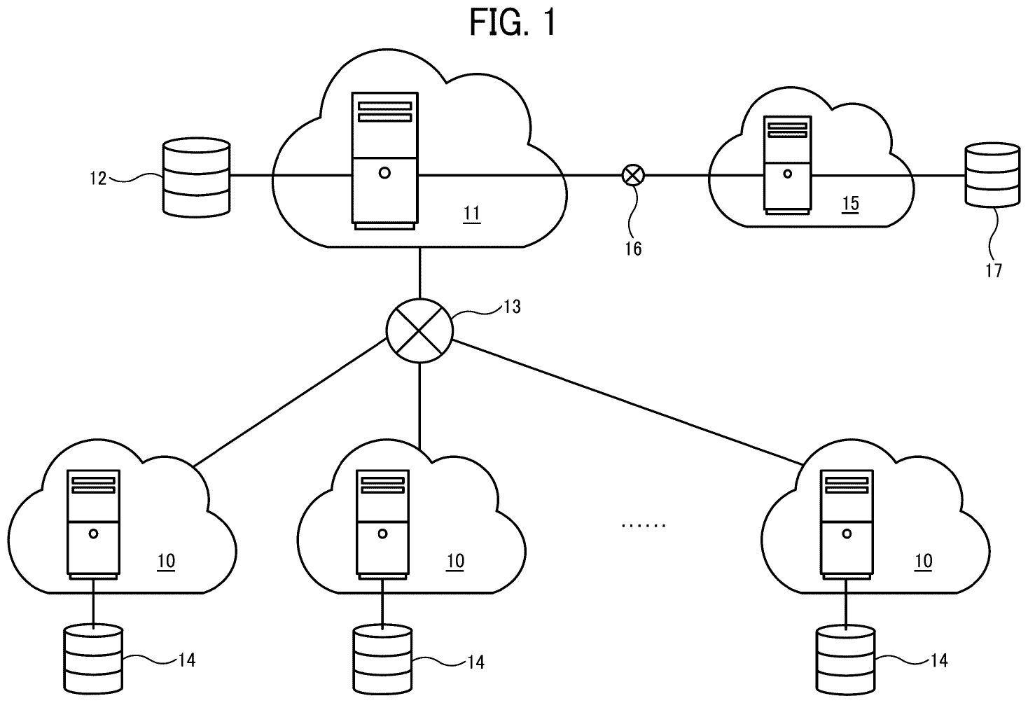

FIG. 1 is a diagram illustrating a configuration of an information processing system. The information processing system is a system for performing federated learning, and includes client apparatuses 10 that are multiple information processing apparatuses and a central server 11 that is a management apparatus. In the following description, the client apparatuses 10 are referred to as clients 10, and any one of the clients 10 is referred to as a client 10 unless particularly distinguished from one another. The central server 11 is referred to as a central 11 in the following description.

The central 11 is connected to a storage device 12 that stores data to be held by the central 11, such as central data and central models. The storage device 12, which is implemented by a memory, is connected to each client 10 via a network 13. Each of the central models is a global model constructed using the federated learning.

Each client 10 is installed for, for example, an individual operator or organization. For example, a client A is installed for an organization A, a client B is installed for an organization B different from the organization A, and a client N is installed for an organization N different from the organizations A and B. Each client 10 is connected to a storage device 14 that stores data to be held by each client 10 such as client data and a client model. The client model is a local model subjected to machine learning performed by each client 10 using the client data as a set of data.

The central 11 generates an initial model as one of the central models, and distributes the initial model to each client 10. The models such as the initial model, the central model, and the client model are, for example, neural networks or machine learning models.

A neural network includes multiple processing layers. Each processing layer includes multiple nodes or neurons. The multiple processing layers include an input layer, one or more intermediate layers, and an output layer. The nodes or neurons are assigned weights that are adjusted through the learning process as one of the parameters.

A machine learning model is, for example, an algorithm that, when an input is received, evaluates the content of the input and outputs the evaluation result as an output value. The algorithm is, for example, a function. The simplest function is a linear function. The function includes a coefficient that is adjusted through the learning process as one of the parameters. The models such as the initial model, the central model, and the client model are trained using, for example, training data in the form of a pair of an example question and a correct answer, and the parameters are adjusted.

Each client 10 uses the client data held by each client 10 to perform the machine learning on the distributed initial model, and constructs a client model. Each client 10 transmits the data of the constructed client model to the central 11. The data of the client model is, for example, the parameters described above or the output of the client model.

The central 11 integrates the client models using the data received from each client 10, and newly creates a central model to update and construct the central model. Each client 10 that has performed the federated learning is treated as a federation partner and the constructed central model can be used by each client 10 for the tasks and operations of own.

The information processing system may include, in order to perform the federated learning, an information processing apparatus 15 that does not participate in the federated learning in addition to the clients 10 participating in the federated learning. The information processing apparatus 15 is connected to the central 11 via a network 16. The information processing apparatus 15 is also connected to a storage device 17 that stores data to be held by the information processing apparatus 15. The central 11 may distribute the central model constructed using the federated learning to the information processing apparatus 15 not participating in the federated learning.

The networks 13 and 16 may be wired networks or wireless networks such as wireless local area networks (LANs). The information processing system is not limited to a configuration including the multiple clients 10, the central 11, and the information processing apparatus 15, and may be a configuration including other apparatuses additionally.

In FIG. 1, the central 11 and the storage device 12 are illustrated as separate apparatuses, and the client 10 and the storage device 14 are also illustrated as separate apparatuses, but the configurations are not limited thereto. The central 11 may include the storage device 12, and the client 10 may include the storage device 14.

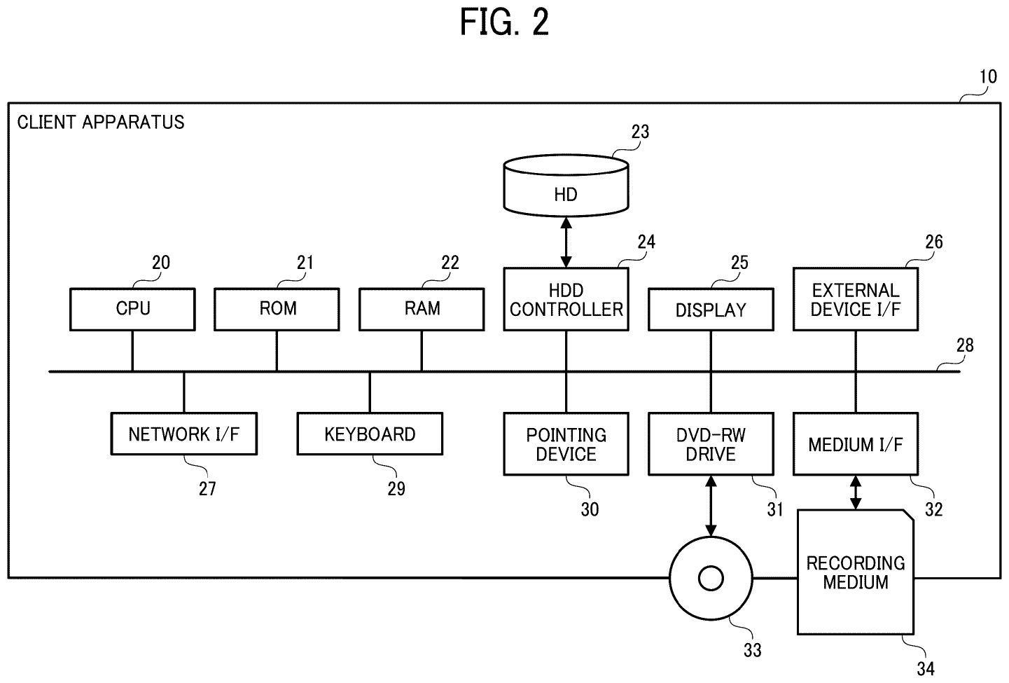

FIG. 2 is a block diagram illustrating a hardware configuration of the client 10, which is one example of an information processing apparatus. Since the hardware configurations of the central 11 and the information processing apparatus 15 are substantially the same as the hardware configuration of the client 10, the descriptions thereof are omitted.

The client 10 is implemented by a computer and includes a central processing unit (CPU) 20, a read-only memory (ROM) 21, a random-access memory (RAM) 22, a hard disk (HD) 23, and a hard disk drive (HDD) controller 24. The client 10 also includes a display 25, an external device interface (I/F) 26, a network I/F 27, a bus line 28, a keyboard 29, a pointing device 30, a digital versatile disc-rewritable (DVD-RW) drive 31, and a medium I/F 32.

The CPU 20 controls the entire operation of the client 10. The ROM 21 stores a program used to boot the CPU 20, such as an initial program loader (IPL) that is first read into the RAM 22 and executed when the client 10 is started. The RAM 22 is used as a work area for the CPU 20. The HD 23 stores various data such as a program. The HD 23 may be used as the storage device 14 connected to the client 10. The HDD controller 24 controls the reading and writing of various data from and to the HD 23 under the control of the CPU 20. The client 10 may include a storage device such as a solid-state drive (SSD) instead of the HD 23.

The display 25 displays various kinds of information such as a cursor, a menu, a window, characters, or an image. The external device I/F 26, which may be implemented by an interface circuit, is an interface for connection with various external devices. Examples of the external devices in this case include, but are not limited to, a universal serial bus (USB) memory and a printer. The network I/F 27, which may be implemented by an interface circuit, is an interface for data communication through the network 13 or 16. The bus line 28 is, for example, an address bus or a data bus, which electrically connects the components or elements such as the CPU 20 to each other.

The keyboard 29 serves as an input device provided with a plurality of keys used for, for example, inputting characters, numerical values, and various instructions. The pointing device 30 serves as an input device used for, for example, selecting or executing various instructions, selecting an object to be processed, and moving a cursor being displayed. The DVD-RW drive 31 controls the reading and writing of various data from and to a DVD-RW 33, which serves as a removable recording medium according to the present embodiment. The removable recording medium is not limited to the DVD-RW 33 and may be, for example, a digital versatile disc-recordable (DVD-R), a compact disc rewritable (CD-RW), or a compact disc-recordable (CD-R). The medium I/F 32, which may be implemented by an interface circuity, controls the reading and writing of data from and to a recording medium 34 such as a flash memory.

The client 10 may include other hardware additionally. Examples of the other hardware include an audio input device such as a microphone, an audio output device such as a speaker, and an imaging device such as a camera.

The computer that implements each of the client 10, the central 11, and the information processing apparatus 15 is not limited to the computer such as a general-purpose personal computer (PC) illustrated in FIG. 2, but may be any apparatus that can perform the federated learning, such as a multifunctional peripheral (MFP).

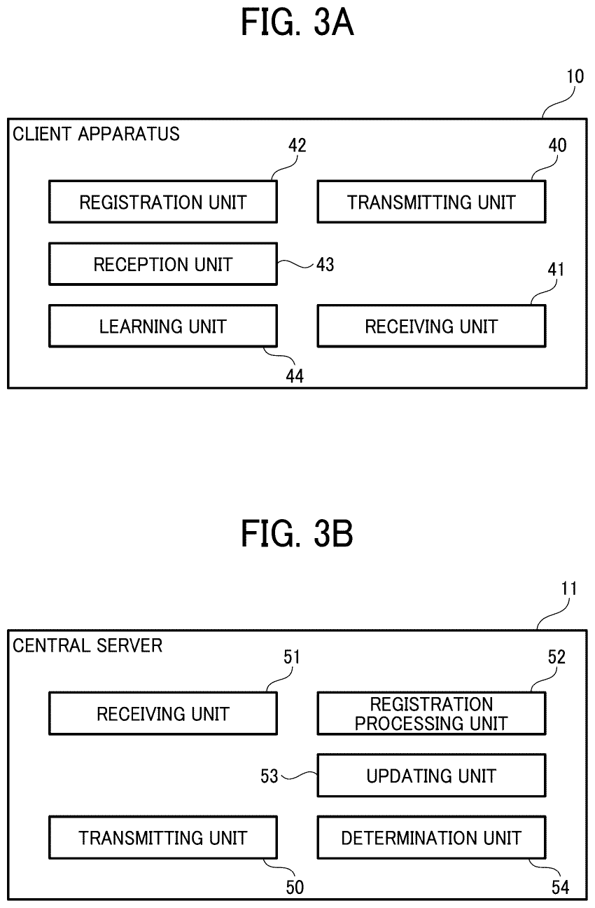

FIG. 3A is a block diagram illustrating a functional configuration of the client 10. FIG. 3B is a block diagram illustrating a functional configuration of the central 11. The client 10 and the central 11 operate in cooperation with each other to perform the federated learning, and have multiple functions for executing the processing. Each function is implemented by one or more processing circuits or circuitry. The “processing circuit or circuitry” herein includes a programmed processor to execute each function by software, such as a processor implemented by an electronic circuit, and devices, such as an application-specific integrated circuit (ASIC), a digital signal processor (DSP), a field-programmable gate array (FPGA), and circuit modules known in the art arranged to perform the recited functions.

The client 10 includes a transmitting unit 40, a receiving unit 41, a registration unit 42, a reception unit 43, and a learning unit 44. The transmitting unit 40 transmits, for example, the data of the client model to the central 11. The receiving unit 41 receives, for example, the initial model (the data of the initial model) distributed by the central 11 and the central model (the data of the central model) created by integrating the received client models. The receiving unit 41 functions as an obtaining unit and obtains, for example, related information from the central 11.

The registration unit 42 transmits the data of the client model on which the machine learning has been performed to the central 11 via the transmitting unit 40 for the registration of the data in the storage device 12 connected to the central 11. Specifically, the registration unit 42 requests the central 11 to register the data transmitted to the storage device 12, and the central 11 stores the data in the storage device 12 to register the data. The registration unit 42 also transmits, to the central 11, the related information associated with the client model constructed by the client 10 for the registration of the related information in association with the corresponding data. Alternatively, the registration unit 42 may register the data in the storage device 14 connected to the client 10.

The related information is, for example, but not limited to, information on the business type, the business operation in which the corresponding data is used, and the purpose of use. Examples of the business type include retail, wholesale, food, communications, agriculture, forestry, mining, manufacturing, construction, transportation, finance, insurance, medical care, welfare, and services. Examples of the business operation include research, development, production, sales, customer service, survey, and daily reports creation. The purpose of use is the purpose of using the model, and examples thereof include prediction of stock prices or energy demand and detection of an object.

The reception unit 43 displays a screen for the operator or an operator of the organization who uses the client 10 and receives input from, for example, the operator. Examples of the organization include a company, a department, and a group. Examples of the screen include a screen used for inputting the related information, a screen used for setting a security policy for the registered data, a screen used for selecting a model, and a screen used for selecting a federation partner. The security policy is a set of rules for maintaining the security of the registered data. The security policy can be set, for example, as a scope in which the use of the data is permitted or an access level. The scope in which the use of the data is permitted is, for example, a scope indicating operators who are permitted to use the data. The access level is the level of authority to access data assigned to an individual operator. Examples of the access level include a level that allows access to all data and a level that restricts access to some data.

The learning unit 44 uses the client data held by the client 10 as learning data to perform the machine learning on the initial model distributed from the central 11. The method of the machine learning is generally well known, and therefore, the description thereof is omitted.

The central 11 includes a transmitting unit 50, a receiving unit 51, a registration processing unit 52, an updating unit 53, and a determination unit 54. The transmitting unit 50 functions as a distribution unit, and transmits, for example, the initial model and the central model to each client 10 for distribution. The receiving unit 51 receives, from each client 10, the data of the client model on which the machine learning has been performed by each client 10 for acquisition.

The registration processing unit 52 stores the client model received from each client 10 in the storage device 12 for registration. The registration processing unit 52 also stores the updated central model in the storage device 12.

The updating unit 53 integrates the stored client models to update the central model. The central model is updated by newly creating a central model using the client model or the output of the client model received from each client 10. The integration of each client model is performed by, for example, taking the average of the above-described parameters of each client model.

The determination unit 54 determines whether an update end condition is satisfied. The update end condition may be, for example, a determination of whether the update of the central model has been repeated a predetermined number of times or a determination of whether a convergence condition is satisfied. The convergence condition may be, for example, a determination of whether an accuracy rate or a recall rate is equal to or greater than a threshold value. The accuracy rate and the recall rate are given by way of example. The convergence condition is not limited to the accuracy rate or the recall rate. The accuracy rate indicates how correct the prediction or classification made by the central model is. Assuming that the correct answer is A, the recall rate indicates how close the prediction made by the central model is to A or how close the classification made by the central is to A.

The more times a model is repeatedly trained, the finer the detail of the data the model learns. Accordingly, the more times the repetition is performed, the finer the detail of the data is taken into consideration for the prediction or classification. As a result, the prediction or classification is less likely to be accurate. This indicates a state called overlearning. The update end condition is set as a condition for ending the update before the state becomes the overlearning state.

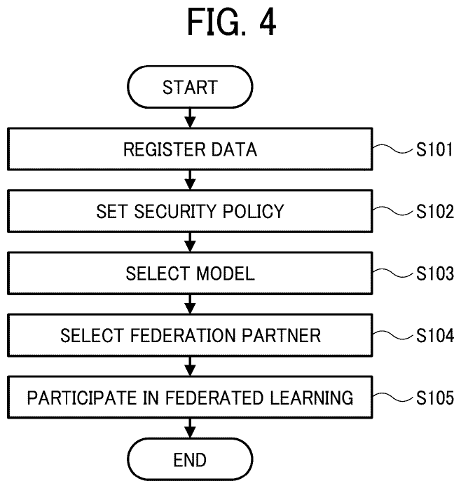

FIG. 4 is a flowchart of the processing executed until the client 10 participates in the federated learning. The operator operates the client 10 to establish communication with the central 11 and the processing starts. The operator is, for example, an individual or an employee belonging to a company who uses the client 10.

In S101, the client 10 transmits data used for creating a model to the central 11 and the central 11 registers the data. The data used for creating the model is, for example, a client model or the output of the client model. The operator inputs information used for creating the model on a screen displayed on the client 10 and transmits the information to the central 11 together with the data. The information used for creating the model is related information associated with the client model, such as information on the business type, the business operation in which the corresponding data is used, or the purpose of use.

In S102, the client 10 displays a screen used for setting a security policy for the registered model, and receives the setting of the security policy set by the operator. The client 10 receives, as a security policy, for example, the designation of the scope in which the use of the model is permitted and an access level. The client 10 transmits the set security policy to the central 11 so that the central 11 stores the policy in association with the data registered in the central 11.

In S103, the client 10 displays registered models and receives a selection by the operator. The operator refers to the information on the task associated with each of the registered models to select a model according to the task that the operator desires to perform. The task represents a work performed using the model. Examples of the task include classification, regression, and clustering. The client 10 not only receives the selection of the model, but also receives parameters associated with the model, and sets the received parameters as initial values. The client 10 transmits information on the selected model to the central 11, and the central 11 registers the model as a model that the operator desires to use. At this time, the information on the selected model is stored in association with the above-described data and related information.

In S104, the client 10 displays a screen used for selecting a federation partner and receives a federation partner selected by the operator. The federation partner is another client that participates in the federated learning. The screen used for selecting a federation partner includes information such as available data sets, the business type of the client 10 of the federation partner participating in the federated learning, and the quality of the data. The operator may select a federation partner based on this information.

With the selection by the operator described above, the federated learning is efficiently performed in accordance with the purpose of use. In addition to the selection by the operator, the client 10 may automatically select the most suitable federation partner based on, for example, the data characteristics of the client 10 of the federation partner, the selected model, and the set security policy.

The client 10 transmits information on the selected federation partner to the central 11, permits the selected federation partner to use the registered data, and registers the selected federation partner as a partner that participates in the federated learning. At this time, the information on the selected federation partner is stored in association with, for example, the above-described data and related information.

In S105, the client 10 participates in a process of the federated learning and cooperates with the partner to jointly train the model. Then, the processing until the client 10 participates in the federated learning ends.

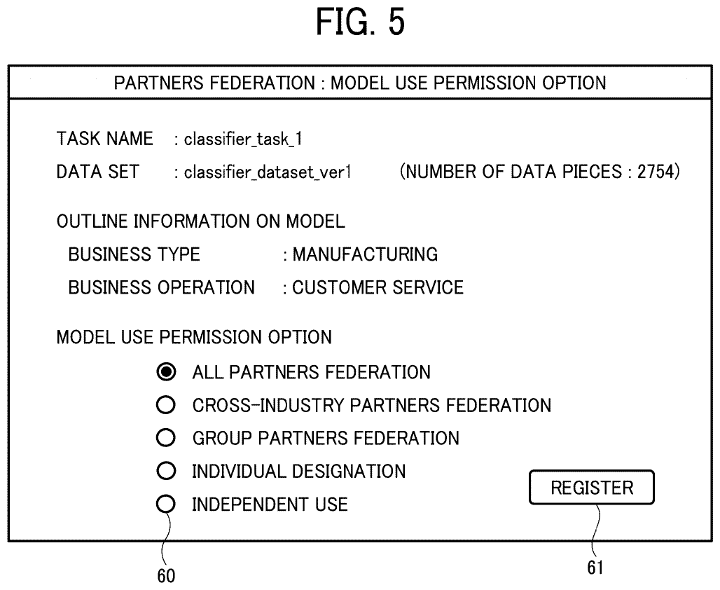

FIG. 5 is a diagram illustrating a model use permission setting screen, which is given by way of example as the screen used for setting the security policy in S102. The model use permission setting screen illustrated in FIG. 5 is displayed on the display 25 of the client 10. On the model use permission setting screen illustrated in FIG. 5, a “TASK NAME” is the name of the task registered by the client 10, and a “DATA SET” is the information on the registered data (data set). In this case, the information on the data set includes the number of pieces of data.

“OUTLINE INFORMATION ON MODEL” is the information of the business type and the business operation input by the operator when the client 10 registers the data. A “MODEL USE PERMISSION OPTION” is for designating a scope in which the use of the model is permitted, which is selected and set for each piece of data registered by the client 10. The operator selects, according to the security tolerance and business needs of the organization to which the operator belongs, one from the options to designate the scope in which the use of the model is permitted. Although the scope is designated by selecting one from the options in the present embodiment, the way for the designation is not limited thereto. The operator may input to designate the scope in which the use of the model is permitted.

In FIG. 5, the number of options of the “MODEL USE PERMISSION OPTION” is five, and one is selected by pressing one of radio buttons 60. The five options are given by way of example as the number of options. The number of options is not limited to five, but may be two to four, or six or more. Further, the way for selecting one of the options is not limited to the way using the radio buttons 60.

“ALL PARTNERS FEDERATION” is an option for permitting all the federation partners participating in the federated learning to use the model as federation partners. In other words, the use of the data registered by the client 10 is permitted to all the federation partners. “CROSS-INDUSTRY PARTNERS FEDERATION” is an option for permitting, as federation partners, only the federation partners, among all the federation partners participating in the federated learning, in the industries different from the industry of the operator using the client 10 or the industry of the organization to which the operator using the client 10 belongs to use the model. By selecting the “CROSS-INDUSTRY PARTNERS FEDERATION,” the risk of data use among competing organizations is reduced. “GROUP PARTNERS FEDERATION” is an option for permitting, as federation partners, among all the federation partners participating in the federated learning, only the federation partners belonging to the group of the operator using the client 10 or the group of the organization to which the operator using the client 10 belongs to use the model. “INDIVIDUAL DESIGNATION” is an option for individually designating individuals or organizations that are permitted to use the model. The “INDIVIDUAL DESIGNATION” is used, for example, when the operator desires to permit only the joint research partners to use the model as federation partners. “INDEPENDENT USE” is an option for preventing the model from being used by any federation partners participating in the federated learning as federation partners.

When the operator selects one of the options of the model use permission option and presses a registration button 61, the information on the scope corresponding to the selection is transmitted to the central 11 and registered as a scope in which the use of the model is permitted.

Specifically, the reception unit 43 receives a selection of whether to permit the use of the data to the federation partners, that is, a selection of one of the five options operated by the operator. The reception unit 43 transmits the information of the selected scope in which the use of the model is permitted to the central 11 via the transmitting unit 40, and the information is stored in the storage device 12 connected to the central 11 in association with the corresponding data and the related information.

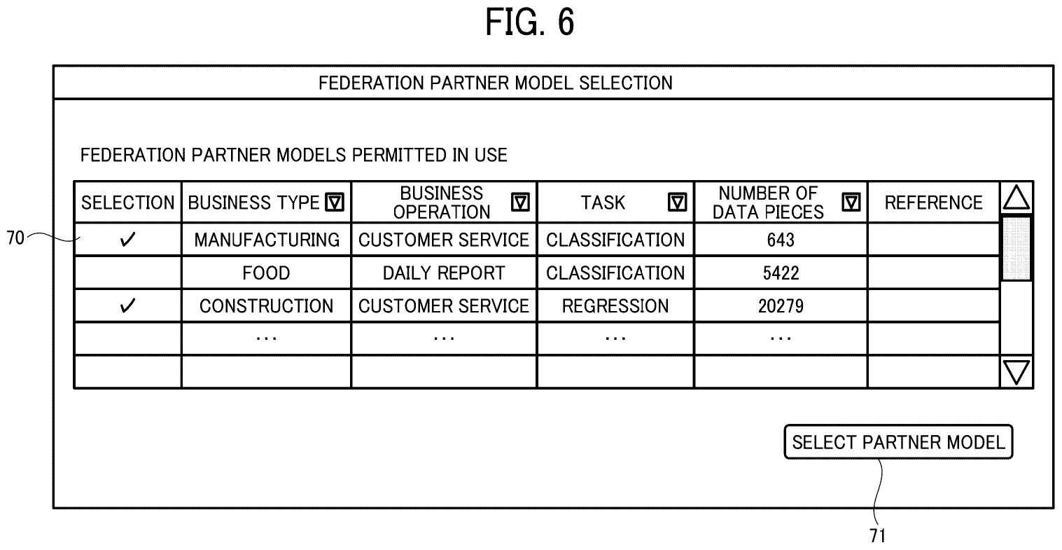

FIG. 6 is a diagram illustrating a screen used for selecting a federation partner in S104. On the screen, a list of models (client models) that are permitted to be used by the client 10 is displayed. The list includes information of the business type and the business operation as the related information associated with the model. The list also includes information such as the type of task and the number of pieces of data when the model is trained.

The list on the screen illustrated in FIG. 6 includes input fields 70 used for selecting a partner by being checked with, for example, the pointing device 30. In FIG. 6, two models of the partners whose business operation is “CUSTOMER SERVICE” are selected. On the screen, a partner model selection button 71 used for confirming the selection of the federation partner is displayed. The operator presses the partner model selection button 71 to determine the selected partners to be federation partners.

A federation partner is selected by selecting a model from the list of models that are permitted to be used by the client 10. For example, in the case where models of clients B to D are permitted to be used by the client A, the client A is allowed to select a federation partner from the clients B to D.

The reception unit 43 requests for the screen used for selecting a federation partner to the central 11 via the transmitting unit 40. The central 11 searches for models permitted to be used by the client 10 based on the information on the selection, and transmits a list of the searched models to the client 10 together with the related information associated with each of the searched models. The reception unit 43 receives the list of models and the related information via the receiving unit 41, and displays, in a selectable manner, a list of related information associated with each of the searched models as a list of models of the partners whose use is permitted. The reception unit 43 receives a selection by the operator of the partners whose models are permitted to be used, and transmits the information on the selected partners to the central 11 via the transmitting unit 40.

The central 11 stores the information on the selected partners in association with, for example, the data registered by the client 10.

When there are a sufficient number of models that the operator is allowed to select in the list as the federation partners, the operator can select one or more models from the list. However, when there are not a sufficient number of models in the list, the operator may desire to apply for the use of a model whose use is not permitted.

In view of the above, the client 10 displays a screen used for applying for the use of a model whose use is not permitted and the operator is allowed to apply for the use of the model to another client 10 that has registered the model.

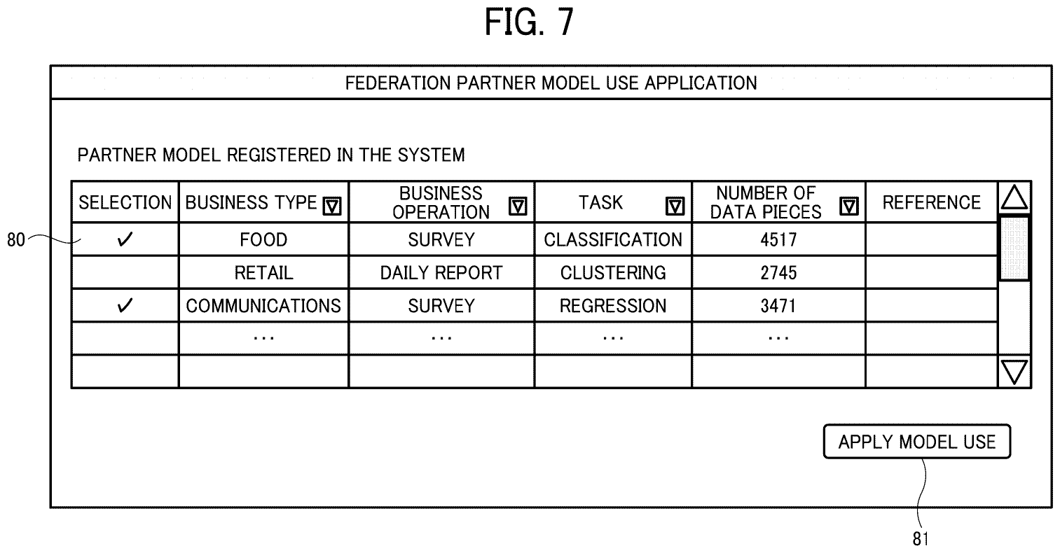

FIG. 7 is a diagram illustrating a screen used for applying for the use of a model. On the screen, a list of models whose use is not permitted to the client 10, among the models registered in the information processing system, is displayed. The list includes information of the business type and the business operation as the related information associated with each of the models. The list also includes information such as the type of task and the number of pieces of data when each of the models is trained.

The list on the screen illustrated in FIG. 7 includes input fields 80 used for selecting a partner by being checked with, for example, the pointing device 30. In FIG. 7, two models of the partners whose business operation is “SURVEY” are selected. On the screen, a model use application button 81 used for confirming the application for the use to a partner is displayed. The operator presses the model use application button 81 to apply for the use of the models to the selected partners.

When the model use application button 81 is pressed, a screen used for approving or rejecting the application is transmitted and displayed in another client 10 of each of the selected partners. An internet protocol (IP) address of the other client 10 of each of the partners is also stored in association with each model. Accordingly, the screen used for approving or rejecting the application is transmitted to the other client 10 of each of the selected partners using, for example, the IP address stored in association with each model of each of the selected partners.

The reception unit 43 requests for the screen used for applying for the use of a model whose use is not permitted to the central 11 via the transmitting unit 40. The central 11 searches for models whose use is not permitted to the client 10 based on the information on the selected partners, and transmits a list of the searched models to the client 10 together with the related information associated with each of the searched models. The reception unit 43 receives the list of the models and the related information via the receiving unit 41, and displays, in a selectable manner, the list of related information associated with each of the searched models as a list of models of the partners whose use is not permitted. The reception unit 43 receives a selection by the operator of the partners to each of which the application for the use is to be made, and transmits the information on each of the selected partners to which the application for the use is to be made to the central 11 via the transmitting unit 40.

The central 11 stores the information on each of the selected partners to which the application for the use is to be made in association with the data registered by the client 10.

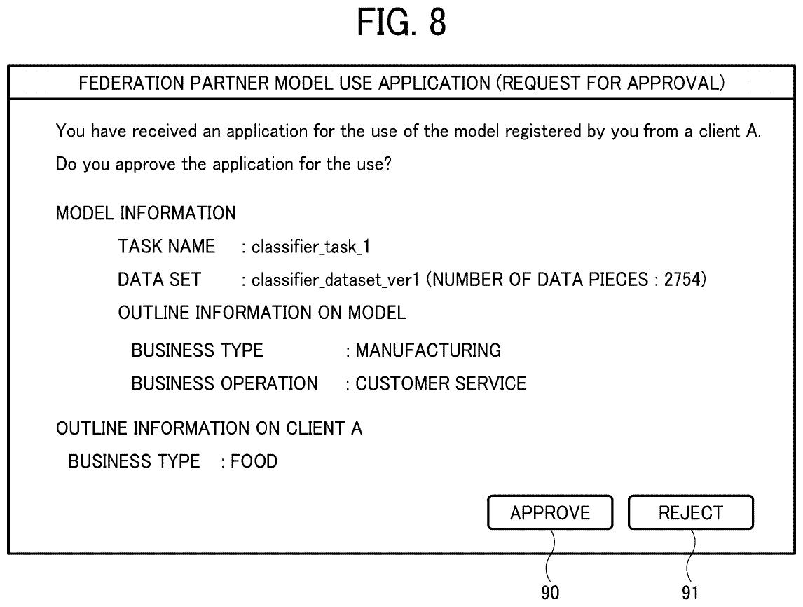

FIG. 8 is a diagram illustrating the screen used for approving or rejecting the application for the use of a model. On the screen, for example, the related information when the security policy of the model (client model) is set, the task name, and information on the data set are displayed as information on the model. On the screen, the information on the client 10 that has applied for the use is also displayed. The information on the client 10 is outline information, such as information of the business type.

The screen includes an approval button 90 used for approving the application for the use and a rejection button 91 used for rejecting the application for the use. When the approval button 90 is pressed, the use of the model for which the application for the use has been made is permitted. When the rejection button 91 is pressed, the use of the model for which the application for the use has been made remains unpermitted.

The screen may include other information additionally. For example, on the screen, at the time of application, information on the purpose of use, such as what type of model is to be developed, may be displayed. In this way, the purpose of use is used as one factor in determining whether to approve or reject the application for the use of the model.

The central 11 receives the application for the use transmitted from the client 10. The central 11 generates a screen presenting the application for the use to the other client 10 of each of the selected federation partners based on the information on each of the selected federation partners to which the application for the use is to be made, and transmits the screen to the other client 10 of each of the selected federation partners. The other client 10 of each of the selected federation partners obtains the screen presenting the application for the use using the receiving unit 41 as an obtaining unit, and receives a selection of whether to approve the application for the use using the reception unit 43. The other client 10 of each of the federation partners transmits a determination of whether to approve the application for the use to the central 11. The central 11 changes, based on the determination, the scope in which the use of the model of the other client 10 of each of the selected partners is permitted.

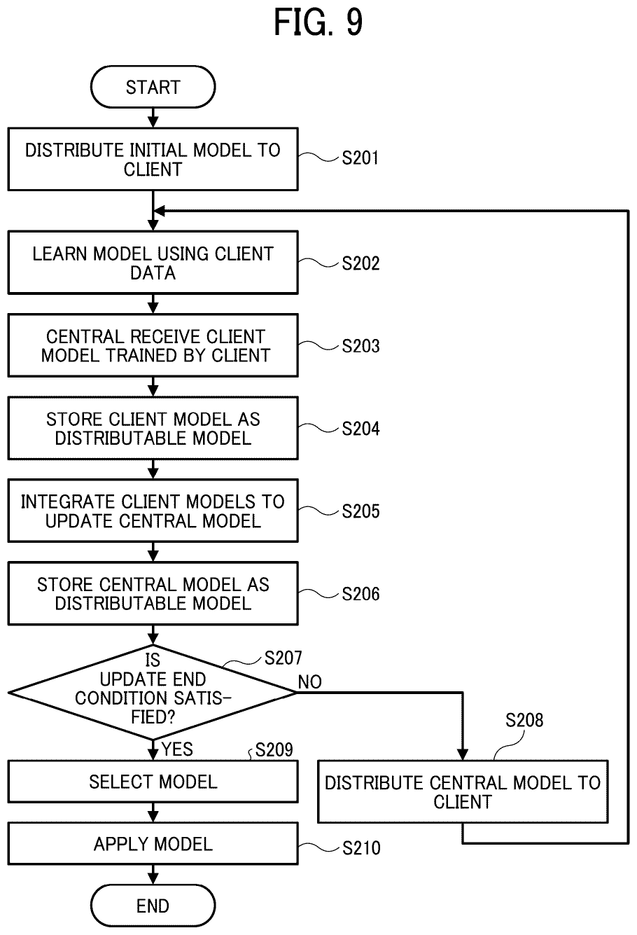

FIG. 9 is a flowchart of the processing to construct a model using the federated learning. The information processing system starts the processing to construct a model using the federated learning. In S201, the central 11 generates an initial model and distributes the initial model to each client 10.

In S202, the client 10 receives the initial model distributed by the central 11, learns the initial model using the data of own (client data), and updates the model. In S203, the central 11 receives the model (client model) trained by the client 10 transmitted from the client 10. The client 10 obtains the evaluation result of the model when the client model is trained, and transmits the evaluation result to the central 11 together with the model. The evaluation result may include, for example, an accuracy rate and a recall rate. The accuracy rate and the recall rate are given by way of example. The evaluation result is not limited to the accuracy rate or the recall rate. The client 10 may transmit the output of the model for specific data, instead of the model.

In S204, the central 11 stores the obtained model in the storage device 12 as a distributable model so that the obtained model can be applied after the model is developed. In this case, the central 11 may store only the best model with the highest evaluation in the cycle of the federated learning identified using one or more received evaluation results. In the present embodiment, the model is stored in the storage device 12 connected to the central 11, but the storage device is not limited thereto. Alternatively, the model may be stored in the storage device 14 connected to the client 10.

In S205, the central 11 integrates the models obtained from each client 10 and stored in the storage device 12 to update the central model. In the case where the models are stored in the storage devices 14 connected to the respective clients 10, the central 11 obtains the models from the clients 10, and newly creates a central model using the models or the outputs of the models to update the central model. At this time, the central 11 may output the evaluation result of the central model.

In S206, the central 11 stores the updated central model in the storage device 12. In this case, the central 11 may store only the best model with the highest evaluation in the cycle of the federated learning identified using the evaluation result of the central model.

In S207, the central 11 determines whether an update end condition of a model is satisfied. The update end condition may be, for example, a determination of whether the update of a model has been repeated a predetermined number of times or a determination of whether a convergence condition is satisfied. In the case where the update end condition is determined not to be satisfied (NO in S207), the processing proceeds to S208, and the central 11 distributes the updated central model to each client 10. Then, the processing returns to S202, and the processes of S202 to S206 are repeated until the update end condition is satisfied.

In the case where the update end condition is determined to be satisfied (YES in S207), the processing proceeds to S209. In S209, the client 10 selects a model most suitable for the task or the business operation of the individual or the organization owning the client 10 from one or more central models constructed using the federated learning and deploy the model. Deploying the model means implementing the model in the environment where the model is actually used and making the model available for use. In S210, the client 10 applies the selected model to the task or the business operation. Then, the processing ends.

According to the federated learning in the art, a client apparatus is allowed only to select to participate in the federated learning. When the data is registered, all other client apparatuses that participate in the federated learning can use the data. As a result, the scope in which the data is federated is uniformly determined, and there is an issue that the scope in which the use of the data is permitted cannot be flexibly changed in accordance with, for example, the security requirements or the business needs of individual organizations.

In addition, there is another issue that some of the organizations participating in the federated learning are competing organizations and the secure use of the data is not guaranteed among the competing organizations.

According to the embodiments described above, each client 10 can freely adjust the security level of the model. Thus, the federated learning can be performed in a security environment that meets the security requirements and business needs of the individual or the organization owning each client 10. In addition, by selecting a partner related to the contents to be trained for the model of the client 10, the federated learning is efficiently implemented in accordance with the purpose of use.

Further, by applying for the use of data whose use is not permitted to the client 10 and having the application approved, the model can be trained using more data sources. Thus, the accuracy and applicability of the model increase. Furthermore, by making the data available for use through the processes of the application and the approval of the application, the transparency in the process of the federated learning increases and the client 10 is more likely to actively participate in the federated learning.

The information processing apparatus, the information processing method, and the non-transitory recording medium of the present disclosure have been described with reference to the above-described embodiments. The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

An information processing system for integrating local models using federated learning to construct a global model includes one or more information processing apparatuses to perform machine learning on the local models using a set of data held by each of the one or more information processing apparatuses and a management apparatus to integrate the local models on which the machine learning has been performed to construct the global model.

In the information processing system, each of the one or more information processing apparatuses includes circuitry to register data of the local models on which the machine learning has been performed and receive a designation of a scope in which use of the data is permitted. In addition, the circuitry receives a selection of whether to permit a partner participating in the federated learning to use the data of the local models. Further, the circuitry to receive a selection of whether to apply for use of data of one or more local models not permitted to be used among the data of the local models on which the machine learning has been performed by the one or more other information processing apparatuses. Furthermore, the circuitry receives a selection of whether to approve an application for use of the data from the one or more information processing apparatuses.

In the information processing system, the management apparatus includes another circuitry to update the global model using the data of the local models on which the machine learning has been performed by the one or more information processing apparatuses, and in response to a selection of the global model by each of the one or more information processing apparatuses, transmit data of the global model that satisfies an update end condition and has been updated to each of the one or more information processing apparatuses.

1. An information processing apparatus comprising circuitry configured to:
register data of local models on which machine learning has been performed using a set of data held by the information processing apparatus; and
receive a designation of a scope in which use of the data is permitted,
the local models to be integrated into a global model using federated learning.

2. The information processing apparatus according to claim 1, wherein the circuitry is configured to receive a selection of whether to permit a partner participating in the federated learning to use the data of the local models.

3. The information processing apparatus according to claim 2, wherein the circuitry is further configured to:
obtain related information associated with the data of the local models permitted to be used among data of local models on which machine learning has been performed by one or more other information processing apparatuses, each information processing apparatus having registered the data of the local models; and
display, on a display, the related information in association with the partner that is permitted to use the data in a selectable manner.

4. The information processing apparatus according to claim 1, wherein the circuitry is configured to receive a selection of whether to apply for use of data of one or more local models not permitted to be used among the data of the local models on which the machine learning has been performed by the one or more other information processing apparatuses.

5. The information processing apparatus according to claim 4, wherein the circuitry is further configured to:
obtain related information associated with the data of the one or more local models not permitted to be used; and
display, on a display, the related information in association with the data of the local models for which an application for use can be made in a selectable manner.

6. The information processing apparatus according to claim 4, wherein the circuitry is further configured to:
obtain an application for use of the data from the one or more information processing apparatuses; and
receive a selection of whether to approve the application.

7. An information processing method performed by an information processing apparatus, the method comprising:
registering data of local models on which machine learning has been performed using a set of data held by the information processing apparatus; and
receiving a designation of a scope in which use of the data is permitted,
the local models to be integrated into a global model using federated learning.

8. The information processing method according to claim 7, further comprising receiving a selection of whether to permit a partner participating in the federated learning to use the data of the local models.

9. The information processing method according to claim 7, further comprising receiving a selection of whether to apply for use of data of one or more local models not permitted to be used among the data of the local models on which the machine learning has been performed by the one or more other information processing apparatuses.

10. The information processing method according to claim 7, further comprising receiving a selection of whether to approve an application for use of the data from the one or more information processing apparatuses.

11. A non-transitory recording medium storing a plurality of program codes which, when executed by a computer, causes the computer to perform a method, the method comprising:
registering data of local models on which machine learning has been performed using a set of data held by the information processing apparatus; and
receiving a designation of a scope in which use of the data is permitted,
the local models to be integrated into a global model using federated learning.

12. The non-transitory recording medium according to claim 11, wherein the method further comprises receiving a selection of whether to permit a partner participating in the federated learning to use the data of the local models.

13. The non-transitory recording medium according to claim 11, wherein the method further comprises receiving a selection of whether to apply for use of data of one or more local models not permitted to be used among the data of the local models on which the machine learning has been performed by the one or more other information processing apparatuses.

14. The non-transitory recording medium according to claim 11, wherein the method further comprises receiving a selection of whether to approve an application for use of the data from the one or more information processing apparatuses.
